(19) United States
(12) Patent Application Publication
(10) Pub. No.: US 2026/0120623 A1
(43) Pub. Date: Apr. 30, 2026

(54) DISPLAY DEVICE AND ELECTRONIC DEVICE INCLUDING THE SAME

(71) Applicant: Samsung Display Co., LTD., Yongin-si (KR)

(72) Inventors: JONG-KEUN KIM, Yongin-si (KR); DOHYUN KANG, Yongin-si (KR); DONGHAK PYO, Yongin-si (KR); Jaeun Kim, Yongin-si (KR)

(21) Appl. No.: 19/246,126

(22) Filed: Jun. 23, 2025

(30) Foreign Application Priority Data
Oct. 24, 2024 (KR) 10-2024-0146441

(51) Int. Cl. G09G 3/32

(52) U.S. Cl. CPC G09G 3/32; G09G 2320/0257; G09G 2320/0271

(57) ABSTRACT

A display device may include a display panel including a plurality of display regions and a display panel driver which drives the display panel. The display panel may emit with a first display pattern during a first time period. When the display panel may emit with the first display pattern, a first display region may emit with a first high grayscale, and a second display region may emit with a first low grayscale lower than the first high grayscale. When the display panel emits with the first display pattern, at least one pixel of the second display region may emit with a second low grayscale which is inconsistent with the first high grayscale and the first low grayscale.

This application claims priority to Korean Patent Application No. 10-2024-0146441, filed on October 24 2024, and all the benefits accruing therefrom under 35 U.S.C. § 119, the content of which in its entirety is herein incorporated by reference.

### BACKGROUND

### 1. Field

Embodiments of the inventive concept relate to a display device and an electronic device. More particularly, embodiments of the inventive concept relate to a display device and an electronic device in which an afterimage is reduced.

### 2. Description of the Related Art

Generally, a display device includes a display panel and a display panel driver. The display panel includes a plurality of gate lines, a plurality of data lines, a plurality of emission lines and a plurality of pixels. The display panel driver includes a gate driver providing a gate signal to the gate lines, a data driver providing a data voltage to the data lines and a driving controller controlling the gate driver, the data driver and the emission driver.

### SUMMARY

Generally, when a pixel is deteriorated to a certain grayscale, an afterimage may be visible.

Embodiments of the inventive concept provide a display device in which an afterimage is reduced.

Embodiments of the inventive concept provide an electronic device in which an afterimage is reduced.

In an embodiment of the disclosure, a display device may include a display panel including a plurality of display regions and a display panel driver which drives the display panel. The display panel may emit with a first display pattern during a first time period. When the display panel may emit with the first display pattern, a first display region may emit with a first high grayscale, and a second display region may emit with a first low grayscale lower than the first high grayscale. When the display panel emits with the first display pattern, at least one pixel of the second display region may emit with a second low grayscale level which is inconsistent with the first high grayscale and the first low grayscale.

In an embodiment, the first display pattern may be a mosaic pattern which is a first sub-pattern emitting as the first high grayscale and a second sub-pattern emitting as the first low grayscale are alternatively disposed.

In an embodiment, the first high grayscale may be a maximum grayscale in which the display panel emits, the first low grayscale may be a minimum grayscale in which the display panel emits, and a first difference value of the second low grayscale and the first low grayscale may be smaller than a second difference value of the second low grayscale and the first high grayscale.

In an embodiment, the first low grayscale may be 0 grayscale level, and the second low grayscale may be a grayscale level which is same or higher than 1 grayscale level.

In an embodiment, the at least one pixel may include a driving transistor which generates a driving current based on a data voltage and a light emitting element which emits light based on the driving current. When a second data voltage corresponding to the first low grayscale is applied to the driving transistor, the driving transistor may be turned off. When a third data voltage corresponding to the second low grayscale is applied to the driving transistor, the driving transistor may be turned on.

In an embodiment, the second display region may include first to fourth pixels. When the display panel emit with the first display pattern, the first to fourth pixels may sequentially emit with the second low grayscale.

In an embodiment, frame periods in which the display panel is driven may include first to fourth frame periods. In the first frame period, the first pixel may emit with the second low grayscale, the second pixel may emit with the first low grayscale, the third pixel may emit with the first low grayscale, and the fourth pixel may emit with the first low grayscale. In the second frame period following to the first frame period, the first pixel may emit with the first low grayscale, the second pixel may emit with the second low grayscale, the third pixel may emit with the first low grayscale, and the fourth pixel may emit with the first low grayscale. In the third frame period following to the second frame period, the first pixel may emit with the first low grayscale, the second pixel may emit with the first low grayscale, the third pixel may emit with the second low grayscale, and the fourth pixel may emit with the first low grayscale. In the fourth frame period following to the third frame period, the first pixel may emit with the first low grayscale, the second pixel may emit with the first low grayscale, the third pixel may emit with the first low grayscale, and the fourth pixel may emit with the second low grayscale.

In an embodiment, the second display region may include first to ninth pixels. When the display panel emit with the first display pattern, the first to ninth pixel sequentially may emit with the second low grayscale.

In an embodiment, the second display region may include a plurality of pixel groups. Each of the pixel groups may include a plurality of pixels. When the display panel emits with the first display pattern, at least one pixel of the plurality of pixels may emit with the second low grayscale.

In an embodiment, during a second time period following to the first time period, the display panel may emit with a reference display pattern. The reference display pattern may be an image in which the entirety of the display panel emits with a reference grayscale.

In an embodiment, the display panel may emit with the first display pattern, at least one pixel of the plurality of pixels included in the first display region may emit with a second high grayscale which is inconsistent with the first high grayscale, the first low grayscale and the second low grayscale.

In an embodiment, the first high grayscale may be a maximum grayscale in which the display panel emits, the first low grayscale may be a minimum grayscale in which the display panel emits, a first difference value of the second low grayscale and the first low grayscale may be smaller than a second difference value of the second low grayscale and the first high grayscale. A third difference value of the second high grayscale and the first high grayscale may be smaller than a fourth difference value of the second high grayscale and the first low grayscale.

In an embodiment, the first high grayscale may be 255 grayscale level, the first low grayscale may be 0 grayscale level, the second low grayscale may be a grayscale level which is same or higher than 1 grayscale level, and the second high grayscale may be a grayscale level which is same or lower than 254 grayscale level.

In an embodiment of the disclosure, a display device may include a display panel including a plurality of display regions and a display panel driver which drives the display panel. The display panel may emit with a first display pattern during a first time period. When the display panel emits with the first display pattern, a first display region may emit with a first high grayscale, a second display region may emit with a first low grayscale which is inconsistent with the first high grayscale. When the display panel emits with the first display pattern, at least one pixel of a plurality of pixels included in the first display region may emit with a second high grayscale which is inconsistent with the first high grayscale and the first low grayscale.

In an embodiment, the first display pattern may be a mosaic pattern which is a first sub-pattern emitting as the first high grayscale and a second sub-pattern emitting as the first low grayscale are alternatively disposed.

In an embodiment, the first high grayscale may be a maximum grayscale in which the display panel emits, the first low grayscale may be a minimum grayscale in which the display panel emits, and a first difference value of the second high grayscale and the first high grayscale may be smaller than a second difference value of the second high grayscale and the first low grayscale.

In an embodiment, the at least one pixel may include a driving transistor which generates a driving current based on a data voltage and a light emitting element which emits light based on the driving current. When a first data voltage corresponding to the first high grayscale is applied to the driving transistor, the driving transistor may output a first driving current corresponding to the 255 grayscale level. When a third data voltage corresponding to the second high grayscale is applied to the driving transistor, the driving transistor may output a second driving current corresponding to the grayscale level which is same or lower than 254 grayscale level.

In an embodiment, a processor which outputs input image data and an input control signal, a display panel including a plurality of display regions and a display panel driver which drives the display panel based on the input image data and the input control signal. The display panel may emit with a first display pattern during a first time period. When the display panel emits with the first display pattern, a first display region may emit with a first high grayscale, and a second display region may emit with a first low grayscale lower than the first high grayscale. When the display panel emits with the first display pattern, at least one pixel of the second display region may emit with a second low grayscale level which is inconsistent with the first high grayscale and the first low grayscale.

In an embodiment, the first display pattern may be a mosaic pattern which is a first sub-pattern emitting as the first high grayscale and a second sub-pattern emitting as the first low grayscale are alternatively disposed.

In an embodiment, the first high grayscale may be a maximum grayscale in which the display panel emits, the first low grayscale may be a minimum grayscale in which the display panel emits, and a first difference value of the second low grayscale and the first low grayscale may be smaller than a second difference value of the second low grayscale and the first high grayscale.

In an embodiment, the at least one pixel may include a driving transistor which generates a driving current based on a data voltage and a light emitting element which emits light based on the driving current. When a second data voltage corresponding to the first low grayscale is applied to the driving transistor, the driving transistor may be turned off. When a third data voltage corresponding to the second low grayscale is applied to the driving transistor, the driving transistor may be turned on.

In an embodiment, the second display region may include first to fourth pixels. When the display panel emit with the first display pattern, the first to fourth pixels may sequentially emit with the second low grayscale.

In an embodiment, In an embodiment, frame periods in which the display panel is driven may include first to fourth frame periods. In the first frame period, the first pixel may emit with the second low grayscale, the second pixel may emit with the first low grayscale, the third pixel may emit with the first low grayscale, and the fourth pixel may emit with the first low grayscale. In the second frame period following to the first frame period, the first pixel may emit with the first low grayscale, the second pixel may emit with the second low grayscale, the third pixel may emit with the first low grayscale, and the fourth pixel may emit with the first low grayscale. In the third frame period following to the second frame period, the first pixel may emit with the first low grayscale, the second pixel may emit with the first low grayscale, the third pixel may emit with the second low grayscale, and the fourth pixel may emit with the first low grayscale. In the fourth frame period following to the third frame period, the first pixel may emit with the first low grayscale, the second pixel may emit with the first low grayscale, the third pixel may emit with the first low grayscale, and the fourth pixel may emit with the second low grayscale.

In an embodiment of the invention, a display device may include a display panel including a plurality of display regions and a display panel driver which drives the display panel. The display panel may emit with a first display pattern during a first time period. When the display panel emits with the first display pattern, a first data voltage may be applied to a first display region, and a second data voltage which is inconsistent with the first data voltage may be applied to a second display region. When the display panel emits with the first display pattern, a third data voltage which is inconsistent with the first data voltage and the second data voltage may be applied to at least one pixel included in the second display region.

In an embodiment, the first display pattern may be a mosaic pattern which is a first sub-pattern displaying white and a second sub-pattern displaying black are alternatively disposed.

In an embodiment, the first data voltage may be a voltage corresponding to a maximum grayscale in which the display panel emits, the second data voltage may be a voltage corresponding to a minimum grayscale in which the display panel emits, and a first difference value of the third data voltage and the second data voltage may be smaller than a second difference value of the third data voltage and the first data voltage.

As described above, when the display panel displays the first display pattern, at least one pixel of the pixels included in the low grayscale region may emit with the second low grayscale. Additionally, in each of frame periods, the at least one pixel may be changed. Accordingly, the driving transistor included in the at least one pixel may be turned on. Accordingly, an influence of the hysteresis may be reduced. The influence of the hysteresis may be reduced, so that a visibility of the afterimage may be reduced. Additionally, a reliability of the afterimage determination may be improved.

Additionally, in an embodiment, the second low grayscale may be about 1 grayscale level. Accordingly, when the at least one pixel emits with the second low grayscale, the low grayscale region may be displayed as black. In an embodiment, when the at least one pixel emits with the second low grayscale, the low grayscale region may emit with a luminance corresponding black, for example. Accordingly, a reliability of the afterimage determination may be further improved.

### BRIEF DESCRIPTION OF THE DRAWINGS

Illustrative, non-limiting embodiments will be more clearly understood from the following detailed description in conjunction with the accompanying drawings.

FIG. 1 is a block diagram illustrating an embodiment of a display device according to the inventive concept.

FIG. 2 is a circuit diagram illustrating an embodiment of a pixel included in a display device.

FIG. 3 is a diagram illustrating an embodiment of a display pattern displayed on a display panel included in a display device.

FIG. 4 is a diagram illustrating a case in which a first display pattern of FIG. 3 is displayed on a display panel of FIG. 1.

FIG. 5 is a diagram illustrating a case when a second display pattern of FIG. 3 is displayed on a display panel of FIG. 1.

FIG. 6 is a diagram illustrating a high grayscale region of display regions of a display panel of FIG. 4.

FIG. 7 is a diagram illustrating an emission of a low grayscale region of display regions of a display panel of FIG. 4 in a first frame period.

FIG. 8 is a diagram illustrating an emission of a low grayscale region of display regions of a display panel of FIG. 4 in a second frame period.

FIG. 9 is a diagram illustrating an emission of a low grayscale region of display regions of a display panel of FIG. 4 in a third frame period.

FIG. 10 is a diagram illustrating an emission of a low grayscale region of display regions of a display panel of FIG. 4 in a fourth frame period.

FIG. 11 is a diagram illustrating an emission of a low grayscale region of display regions of a display panel of FIG. 4 in a first frame period.

FIG. 12 is a diagram illustrating an emission of a low grayscale region of display regions of a display panel of FIG. 4 in a second frame period.

FIG. 13 is a diagram illustrating an emission of a low grayscale region of display regions of a display panel of FIG. 4 in a third frame period.

FIG. 14 is a diagram illustrating an emission of a low grayscale region of display regions of a display panel of FIG. 4 in a fourth frame period.

FIG. 15 is a diagram illustrating an emission of a low grayscale region of display regions of a display panel of FIG. 4 in a fifth frame period.

FIG. 16 is a diagram illustrating an emission of a low grayscale region of display regions of a display panel of FIG. 4 in a sixth frame period.

FIG. 17 is a diagram illustrating an emission of a low grayscale region of display regions of a display panel of FIG. 4 in a seventh frame period.

FIG. 18 is a diagram illustrating an emission of a low grayscale region of display regions of a display panel of FIG. 4 in an eighth frame period.

FIG. 19 is a diagram illustrating an emission of a low grayscale region of display regions of a display panel of FIG. 4 in a ninth frame period.

FIG. 20 is a graph illustrating an afterimage determination of a conventional display device and a display device of FIG. 1.

FIG. 21 is a diagram illustrating an emission of a high grayscale region of display regions of a display panel of FIG. 4 in a first frame period.

FIG. 22 is a diagram illustrating an emission of a high grayscale region of display regions of a display panel of FIG. 4 in a second frame period.

FIG. 23 is a diagram illustrating an emission of a high grayscale region of display regions of a display panel of FIG. 4 in a third frame period.

FIG. 24 is a diagram illustrating an emission of a high grayscale region of display regions of a display panel of FIG. 4 in a fourth frame period.

FIG. 25 is a circuit diagram illustrating an embodiment of a pixel included a display device of FIG. 1.

FIG. 26 is a circuit diagram illustrating an embodiment of a pixel included a display device of FIG. 1.

FIG. 27 is a block diagram illustrating an embodiment of an electronic device according to the inventive concept.

FIG. 28 is a diagram illustrating an embodiment in which the electronic device of FIG. 27 is implemented as a smart phone.

### DETAILED DESCRIPTION OF THE INVENTIVE CONCEPT

Hereinafter, the inventive concept will be explained in detail with reference to the accompanying drawings.

It will be understood that when an element is referred to as being “on” another element, it may be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or. ” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” may therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” may, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). The term such as “about” may mean within one or more standard deviations, or within ±30%, 20%, 10%, 5% of the stated value, for example.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

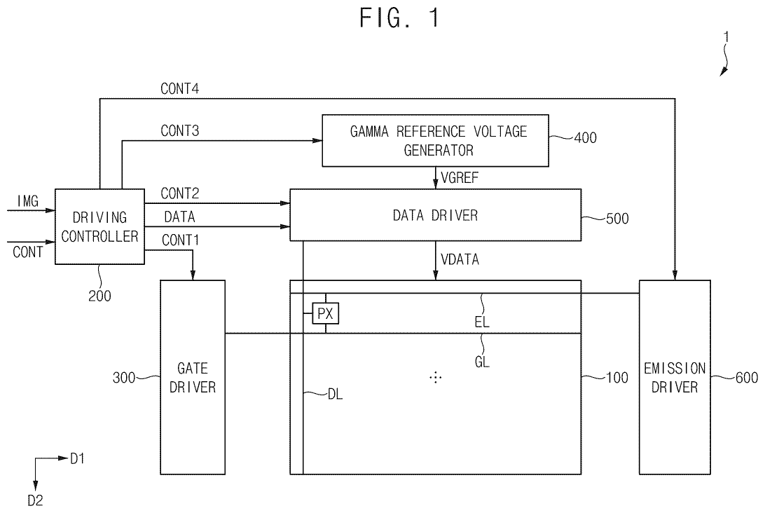

FIG. 1 is a block diagram illustrating an embodiment of a display device 1 according to the inventive concept.

Referring to FIG. 1, the display device 1 may include a display panel 100 and a display panel driver. The display panel driver may include a driving controller 200, a gate driver 300, a gamma reference voltage generator 400, a data driver 500 and an emission driver 600.

The display panel 100 may have a display region on which an image is displayed and a peripheral region adjacent to the display region.

The display panel 100 may include a plurality of gate lines GL, plurality of emission lines EL, a plurality of data lines DL and a plurality of pixel circuits PX electrically connected to the gate lines GL, the emission lines EL and the data lines DL. The gate lines GL may extend in a first direction D1, the emission lines EL may extend in the first direction D1 and the data lines DL may extend in a second direction D2 crossing the first direction D1.

The driving controller 200 may receive input image data IMG and an input control signal CONT from an external apparatus. In an embodiment, the input image data IMG may include red image data, green image data and blue image data, for example. The input image data IMG may include white image data. The input image data IMG may include magenta image data, cyan image data and yellow image data. The input control signal CONT may include a master clock signal and a data enable signal. The input control signal CONT may further include a vertical synchronizing signal and a horizontal synchronizing signal.

The driving controller 200 may generate a first control signal CONT1, a second control signal CONT2, a third control signal CONT3, a fourth control signal CONT4 and a data signal DATA based on the input image data IMG and the input control signal CONT.

The driving controller 200 may generate the first control signal CONT1 for controlling an operation of the gate driver 300 based on the input control signal CONT, and output the first control signal CONT1 to the gate driver 300. The first control signal CONT1 may include a vertical start signal and a gate clock signal.

The driving controller 200 may generate the second control signal CONT2 for controlling an operation of the data driver 500 based on the input control signal CONT, and output the second control signal CONT2 to the data driver 500. The second control signal CONT2 may include a horizontal start signal and a load signal.

The driving controller 200 may generate the data signal DATA based on the input image data IMG. The driving controller 200 may output the data signal DATA to the data driver 500.

The driving controller 200 may generate the third control signal CONT3 for controlling an operation of the gamma reference voltage generator 400 based on the input control signal CONT, and output the third control signal CONT3 to the gamma reference voltage generator 400.

The driving controller 200 may generate the fourth control signal CONT4 for controlling an operation of the emission driver 600 based on the input control signal CONT, and output the fourth control signal CONT4 to the emission driver 600. The fourth control signal CONT4 may include the vertical start signal and an emission clock signal. In an embodiment, the gate clock signal and the emission clock signal may be substantially same.

The gate driver 300 may generate gate signals driving the gate lines GL in response to the first control signal CONT1 received from the driving controller 200. The gate driver 300 may output the gate signals to the gate lines GL.

In an embodiment, the gate driver 300 may be disposed in the peripheral region. In an embodiment, the gate driver 300 may be integrated in the peripheral region.

The gamma reference voltage generator 400 may generate a gamma reference voltage VGREF in response to the third control signal CONT3 received from the driving controller 200. The gamma reference voltage generator 400 may provide the gamma reference voltage VGREF to the data driver 500. The gamma reference voltage VGREF may have a value corresponding to a level of the data signal DATA.

In an embodiment, the gamma reference voltage generator 400 may be disposed in the driving controller 200, or in the data driver 500.

The data driver 500 may receive the second control signal CONT2 and the data signal DATA from the driving controller 200, and receive the gamma reference voltages VGREF from the gamma reference voltage generator 400. The data driver 500 may convert the data signal DATA into data voltages VDATA having an analog type using the gamma reference voltages VGREF. The data driver 500 may output the data voltages VDATA to the data lines DL.

The data voltage VDATA may correspond to a grayscale level in which the display panel 100 displays. In an embodiment, a first data voltage may correspond to a first grayscale, for example. In an embodiment, a second data voltage may correspond to a second grayscale, for example. A maximum grayscale level in which the display panel 100 displays may be about 255 grayscale level. The maximum grayscale level in which the display panel 100 displays may be a grayscale level corresponding to white. However, the inventive concept is not limited to the maximum grayscale level in which the display panel 100 displays. In an embodiment, the maximum grayscale level may be about 2047 grayscale level, for example. A minimum grayscale level in which the display panel 100 displays may be about 0 grayscale level. The minimum grayscale level in which the display panel 100 displays may be a grayscale level corresponding to black.

In an embodiment, the data driver 500 may be disposed in the peripheral region. In an embodiment, the data driver 500 may be integrated in the peripheral region.

The emission driver 600 may generate emission signal in response to the fourth control signal CONT4 received from the driving controller 200. The emission driver 600 may output the emission signal to the display panel 100.

In an embodiment, the emission driver 600 may be disposed in the peripheral region. In an embodiment, the emission driver 600 may be integrated in the peripheral region.

Although the gate driver 300 is disposed on a first side of the display panel 100, and the emission driver 600 is disposed on a second side of the display panel 100 in FIG. 1 for convenience of explanation, the inventive concept is not limited thereto. The gate driver 300 and the emission driver 600 may be disposed on the first side of the display panel 100. In an embodiment, the gate driver 300 and the emission driver 600 may be disposed on the peripheral region of the display panel 100 on the same side of the display region of the display panel 100, for example. In an embodiment, the gate driver 300 and the emission driver 600 may be formed integrally with each other, for example.

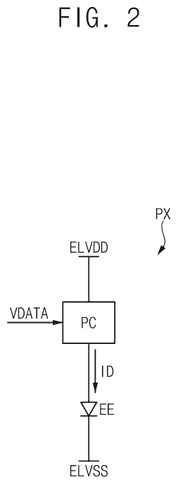

FIG. 2 is a circuit diagram illustrating an embodiment of a pixel PX included in a display device 1.

Referring to FIG. 1 and FIG. 2, the pixel PX may include a circuit block PC and a light emitting element EE. The circuit block PC may receive the data voltage VDATA and a first power voltage ELVDD. The circuit block PC may generate a driving current ID based on the data voltage VDATA and the first power voltage ELVDD. The circuit block PC may include a driving transistor. The driving transistor may generate the driving current ID based on the data voltage VDATA. In an embodiment, when a first data voltage corresponding to a first grayscale is applied to the driving transistor, the driving transistor may generate a first driving current, for example. The light emitting element EE may include a first electrode receiving the driving current ID and a second electrode receiving a second power voltage ELVSS. The light emitting element EE may emit light based on the driving current ID.

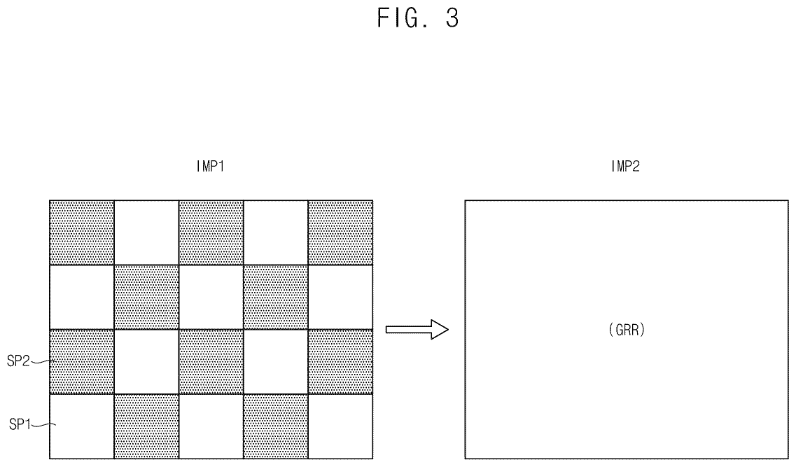

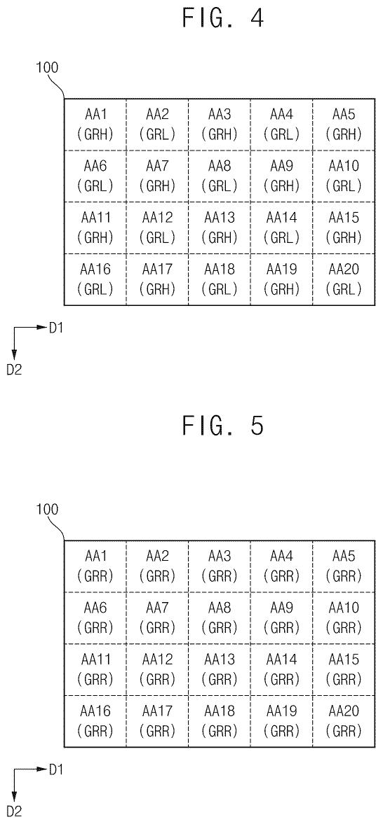

FIG. 3 is a diagram illustrating an embodiment of a display pattern displayed on a display panel 100 included in a display device 1. FIG. 4 is a diagram illustrating a case when a first display pattern IMP1 of FIG. 3 is displayed on a display panel 100 of FIG. 1. FIG. 5 is a diagram illustrating a case when a second display pattern IMP2 of FIG. 3 is displayed on a display panel 100 of FIG. 1.

Referring to FIG. 1 to FIG. 5, the display panel 100 may display a first display pattern IMP1. In an embodiment, the display panel 100 may emit with the first display pattern IMP1, for example. The first display pattern IMP1 may include a first sub-pattern SP1 which emits with a high grayscale GRH, and a second sub-pattern SP2 which emits with a low grayscale GRL. The first display pattern IMP1 may have a mosaic patten in which the first sub pattern SP1 and the second sub pattern SP2 is alternatively disposed. The first display pattern IMP1 may have a check patten in which the first sub pattern SP1 and the second sub pattern SP2 is alternatively disposed. The display panel 100 may display the first display pattern IMP1 during a first time period. In an embodiment, the first time period may be about 30 minutes, for example. However, the inventive concept is not limited to a value of the first time period.

In an embodiment, the display panel 100 may include first to twentieth display regions AA1 to AA20, for example.

When the display panel 100 displays the first display pattern IMP1, the first display region AA1, the third display region AA3, the fifth display region AA5, the seventh display region AA7, the ninth display region AA9, the eleventh display region AA11, the thirteenth display region AA13, the fifteenth display region AA15, the seventeenth display region AA17 and the nineteenth display region AA19 may emit with the first high grayscale GRH1. In an embodiment, the first display region AA1, the third display region AA3, the fifth display region AA5, the seventh display region AA7, the ninth display region AA9, the eleventh display region AA11, the thirteenth display region AA13, the fifteenth display region AA15, the seventeenth display region AA17 and the nineteenth display region AA19 may may emit with a maximum grayscale in which the display panel 100 displays, for example. In an embodiment, the first display region AA1, the third display region AA3, the fifth display region AA5, the seventh display region AA7, the ninth display region AA9, the eleventh display region AA11, the thirteenth display region AA13, the fifteenth display region AA15, the seventeenth display region AA17 and the nineteenth display region AA19 may be referred to as an odd-numbered display region, for example. The pixels PX included in the odd-numbered display region may be deteriorated as the first high grayscale GRH1.

When the display panel 100 displays the first display pattern IMP1, the second display region AA2, the fourth display region AA4, the sixth display region AA6, the eighth display region AA8, the tenth display region AA10, the twelfth display region AA12, the fourteenth display region AA14, the sixteenth display region AA16, the eighteenth display region AA18 and the twentieth display region AA20 may emit with a first low grayscale GRL1. In an embodiment, the second display region AA2, the fourth display region AA4, the sixth display region AA6, the eighth display region AA8, the tenth display region AA10, the twelfth display region AA12, the fourteenth display region AA14, the sixteenth display region AA16, the eighteenth display region AA18 and the twentieth display region AA20 may emit with a minimum grayscale in which the display panel 100 displays, for example. In an embodiment, the second display region AA2, the fourth display region AA4, the sixth display region AA6, the eighth display region AA8, the tenth display region AA10, the twelfth display region AA12, the fourteenth display region AA14, the sixteenth display region AA16, the eighteenth display region AA18 and the twentieth display region AA20 may be referred to as an even-numbered display region, for example. The pixels PX included even-numbered display region may be deteriorated as the first low grayscale GRL1.

After the display panel 100 displays the first display pattern IMP1 during the first time period, the display panel 100 may display a second display pattern IMP2. In an embodiment, the second display pattern IMP2 may be referred to as a reference display pattern, for example. After the display panel 100 displays the first display pattern IMP1 during the first time period, the display panel 100 may display the second display pattern IMP2 during a second time period. In an embodiment, the second time period may be about 10 minutes, for example. However, the inventive concept is not limited to a value of the second time period. The second display pattern IMP2 may emit with reference grayscale GRR. The second display pattern IMP2 may be an image such that the entirety of the display panel 100 may emit with the reference grayscale GRR. In an embodiment, the reference grayscale GRR may be about 31 grayscale level, for example. However, the inventive concept is not limited to a grayscale level of the reference grayscale GRR. In an embodiment, the reference grayscale GRR may be about 30 grayscale level, for example.

When the display panel 100 displays the second display pattern IMP2, the first to twentieth display regions AA1 to AA20 may emit with the reference grayscale GRR.

Based on the first display pattern IMP1 and the second display pattern IMP2, an afterimage of the display panel 100 may be determined. During the first time period, the display panel 100 may display the first display pattern IMP1, so that the odd-numbered display region may be deteriorated as the first high grayscale GRH1, and the even-numbered display region may be deteriorated as the first low grayscale GRL1. After the first time period, the display panel 100 may display the second display pattern IMP2. When the display panel 100 displays the second display pattern IMP2, by a determining apparatus (e.g., a luminance determining apparatus), an afterimage of the display panel 100 may be determined.

When an afterimage of a conventional display device is determined, according to a hysteresis characteristic of a display panel, an afterimage may be more visible. Accordingly, a reliability of an afterimage determination may be deteriorated.

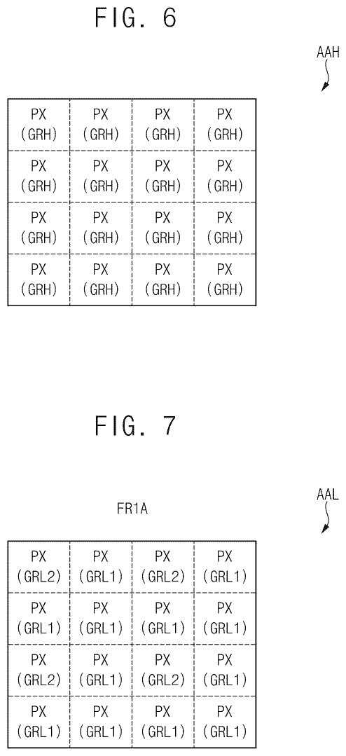

FIG. 6 is a diagram illustrating a high grayscale region AAH of display regions of a display panel 100 of FIG. 4.

Referring to FIG. 1 to FIG. 6, a high grayscale region AAH may include a plurality of pixel groups. The pixel group of the high grayscale region AAH may be referred to as a high grayscale pixel group. The high grayscale region AAH may correspond to the odd-numbered display region. The pixel group may include a plurality of pixels PX. The pixels PX of the high grayscale region AAH may emit with the first high grayscale GRH1. In an embodiment, the pixels PX of the high grayscale region AAH may emit light based on a first high grayscale data voltage corresponding to the first high grayscale GRH1, for example.

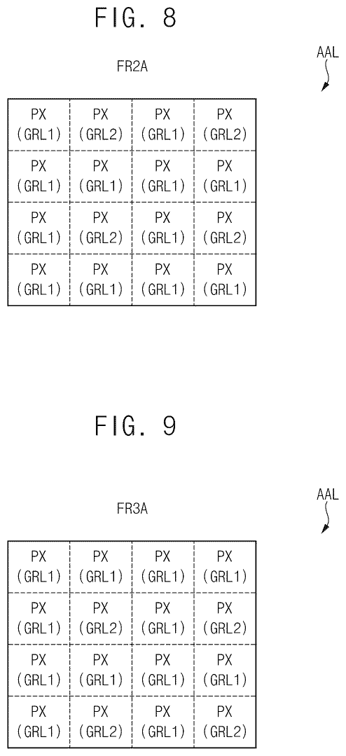

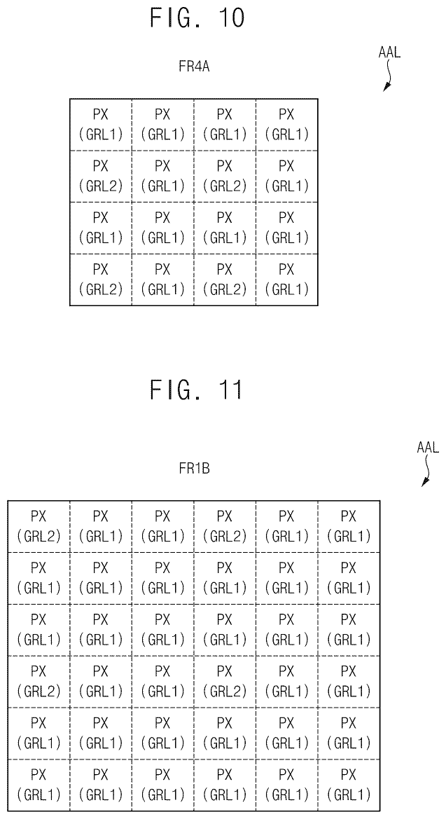

FIG. 7 is a diagram illustrating an emission of a low grayscale region AAL of display regions of a display panel 100 of FIG. 4 in a first frame period FR1A. FIG. 8 is a diagram illustrating an emission of a low grayscale region AAL of display regions of a display panel 100 of FIG. 4 in a second frame period FR2A. FIG. 9 is a diagram illustrating an emission of a low grayscale region AAL of display regions of a display panel 100 of FIG. 4 in a third frame period FR3A. FIG. 10 is a diagram illustrating an emission of a low grayscale region AAL of display regions of a display panel 100 of FIG. 4 in a fourth frame period FR4A.

Referring to FIG. 1 to FIG. 10, a low grayscale region AAL may include a plurality of pixel groups. The pixel group of the low grayscale region AAL may be referred to as a low grayscale pixel group. The low grayscale region AAL may correspond to the even-numbered display region. The pixel group may include a plurality of pixels PX. The pixels PX of the low grayscale region AAL may emit with the first low grayscale GRL1. In an embodiment, the pixels PX of the low grayscale region AAL may emit light based on a first low grayscale data voltage corresponding to the first low grayscale GRL1, for example. When the first low grayscale GRL1 has about 0 grayscale level, the low grayscale region AAL may display black. When the first low grayscale GRL1 has about 0 grayscale level, the driving transistors included in the low grayscale region AAL may be turned off.

In an embodiment, the low grayscale pixel group may include four pixels, for example. In an embodiment, the low grayscale pixel group may include first to fourth pixels. In the illustrated embodiment, at least one pixel of the first to fourth pixels may emit with the second low grayscale GRL2, for example. A grayscale level of the second low grayscale GRL2 may be higher than the grayscale level of the first low grayscale GRL1. The second low grayscale GRL2 may be closer to the first low grayscale GRL1 than the first high grayscale GRH1. In an embodiment, a first difference value of the second low grayscale GRL2 and the first low grayscale GRL1 may be smaller than a second difference value of the second low grayscale GRL2 and the first high grayscale GRH1, for example. In an embodiment, a first data voltage (e.g., the first high grayscale data voltage) may correspond to a maximum grayscale in which the display panel 100 emit, for example. A second data voltage (e.g., the first low grayscale data voltage) may correspond to a minimum grayscale in which the display panel 100 emit. A first voltage difference value of the third data voltage and the second data voltage may be lower than a second voltage difference value of the third data voltage and the first data voltage. In an embodiment, the second low grayscale GRL2 may be about 1 grayscale level, for example. In an embodiment, the second low grayscale GRL2 may be a grayscale level higher than about 1 grayscale level, for example. In an embodiment, the second low grayscale GRL2 may be grayscale level in which a black luminance is not affected, for example. In an embodiment, the first to fourth pixels may sequentially emit with the second low grayscale GRL2, for example. In an embodiment, the first to fourth pixels may randomly emit with the second low grayscale GRL2.

When the pixel PX emits with the first low grayscale GRL1, the driving transistor included in the pixel PX may be turned off. In an embodiment, the first low grayscale data voltage corresponding to the first low grayscale GRL1 may strongly turn off the driving transistor. In an embodiment, an absolute value of the first low grayscale data voltage may be lower than an absolute value of a threshold voltage of the driving transistor, for example. In an embodiment, a difference value of the absolute value of the first low grayscale data voltage and the absolute value of the threshold voltage of the driving transistor may be about 0.5 volt (V), for example. However, the inventive concept is not limited to the difference value. In an embodiment, the difference value may be about 1V, for example.

When the pixel PX emit with the second low grayscale GRL2, the driving transistor included in the pixel PX may be turned on. The driving transistor included in the pixel PX may be turned on, so that a hysteresis characteristic may be improved. In an embodiment, the driving transistor included in the pixel PX, an influence of the hysteresis may be reduced, for example.

In a first frame period FR1A, the first pixel may emit with the second low grayscale GRL2, the second pixel may emit with the first low grayscale GRL1, the third pixel may emit with the first low grayscale GRL1, and the fourth pixel may emit with the first low grayscale GRL1. Accordingly, in the first frame period FR1A, the driving transistor of the first pixel may be turned on, the driving transistor of the second pixel may be maintained as the turned off state, the driving transistor of the third pixel may be maintained as the turned off state, and the driving transistor of the fourth pixel may be maintained as the turned off state. Accordingly, the hysteresis of the first pixel may be improved.

In a second frame period FR2A following to the first frame period FR1A, the first pixel may emit with the first low grayscale GRL1, the second pixel may emit with the second low grayscale GRL2, the third pixel may emit with the first low grayscale GRL1, and the fourth pixel may emit with the first low grayscale GRL1. Accordingly, in the second frame period FR2A, the driving transistor of the first pixel may be turned off, the driving transistor of the second pixel may be turned on, the driving transistor of the third pixel may be maintained as the turned off state, and the driving transistor of the fourth pixel may be maintained as the turned off state. Accordingly, the hysteresis of the second pixel may be improved.

In a third frame period FR3A following to the second frame period FR2A, the first pixel may emit with the first low grayscale GRL1, the second pixel may emit with the first low grayscale GRL1, the third pixel may emit with the second low grayscale GRL2, and the fourth pixel may emit with the first low grayscale GRL1. Accordingly, in the third frame period FR3A, the driving transistor of the first pixel may be maintained as a turned off state, the driving transistor of the second pixel may be turned off, the driving transistor of the third pixel may be turned on, and the driving transistor of the fourth pixel may be maintained as the turned off state. Accordingly, the hysteresis of the third pixel may be improved.

In a fourth frame period FR4A following to the third frame period FR3A, the first pixel may emit with the first low grayscale GRL1, the second pixel may emit with the first low grayscale GRL1, the third pixel may emit with the first low grayscale GRL1, and the fourth pixel may emit with the second low grayscale GRL2. Accordingly, in the fourth frame period FR4A, the driving transistor of the first pixel may be maintained as a turned off state, the driving transistor of the second pixel may be maintained as a turned off state, the driving transistor of the third pixel may be turned off, and the driving transistor of the fourth pixel may be turned on. Accordingly, the hysteresis of the fourth pixel may be improved.

In the illustrated embodiment, when the display panel 100 displays the first display pattern IMP1, at least one pixel of the pixels PX included in the low grayscale region AAL may emit with the second low grayscale GRL2. In an embodiment, at least one pixel of pixels included in the low grayscale pixel group may emit with the second low grayscale GRL2, for example. Additionally, in each of frame periods, the at least one pixel may be changed. Accordingly, the driving transistor included in the at least one pixel may be turned on. Accordingly, an influence of the hysteresis may be reduced. The influence of the hysteresis may be reduced, so that a visibility of the afterimage may be reduced. Additionally, a reliability of the afterimage determination may be improved.

Additionally, in an embodiment, the second low grayscale GRL2 may be about 1 grayscale level. Accordingly, when the at least one pixel emits with the second low grayscale GRL2, the low grayscale region AAL may be displayed as black. In an embodiment, when the at least one pixel emits with the second low grayscale GRL2, the low grayscale region AAL may emit with a luminance corresponding black, for example. Accordingly, a reliability of the afterimage determination may be further improved.

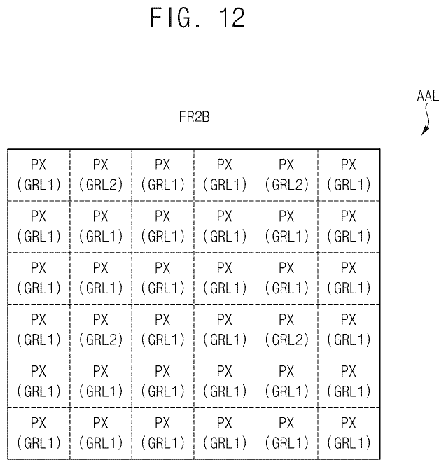

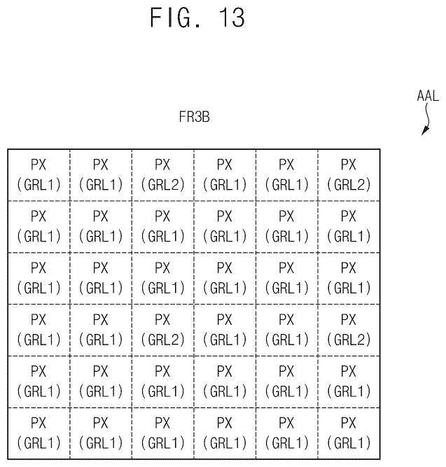

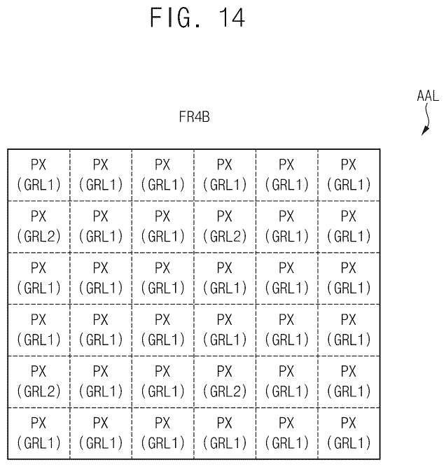

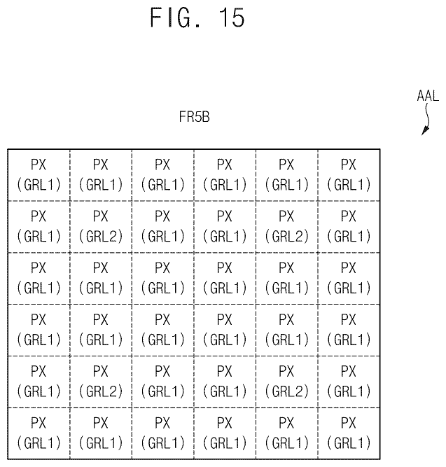

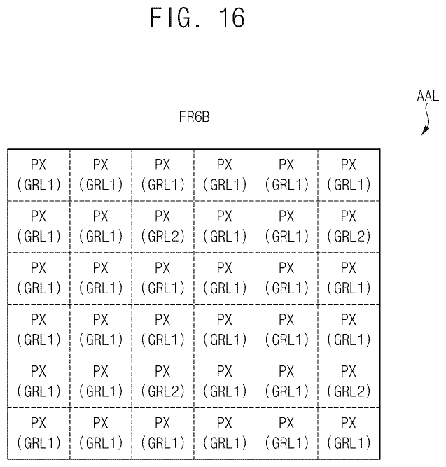

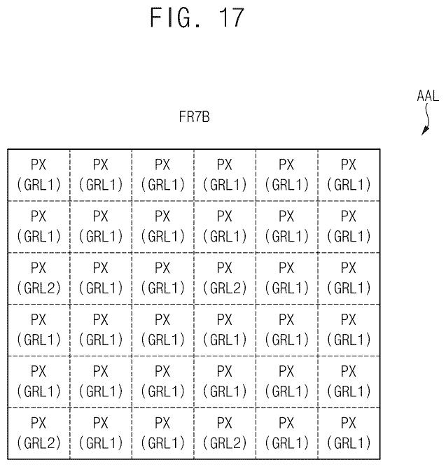

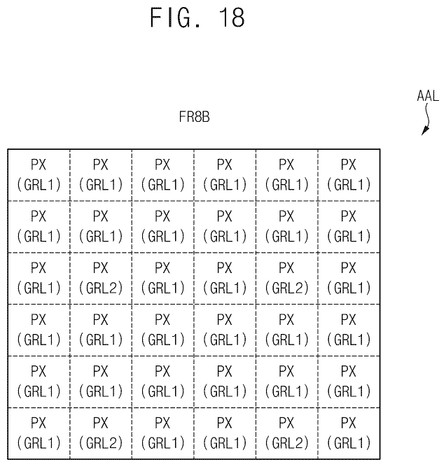

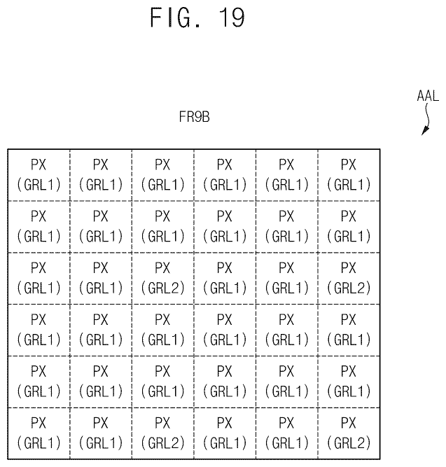

FIG. 11 is a diagram illustrating an emission of a low grayscale region AAL of display regions of a display panel 100 of FIG. 4 in a first frame period FR1B. FIG. 12 is a diagram illustrating an emission of a low grayscale region AAL of display regions of a display panel 100 of FIG. 4 in a second frame period FR2B. FIG. 13 is a diagram illustrating an emission of a low grayscale region AAL of display regions of a display panel 100 of FIG. 4 in a third frame period FR3B. FIG. 14 is a diagram illustrating an emission of a low grayscale region AAL of display regions of a display panel 100 of FIG. 4 in a fourth frame period FR4B. FIG. 15 is a diagram illustrating an emission of a low grayscale region AAL of display regions of a display panel 100 of FIG. 4 in a fifth frame period FR5B. FIG. 16 is a diagram illustrating an emission of a low grayscale region AAL of display regions of a display panel 100 of FIG. 4 in a sixth frame period FR6B. FIG. 17 is a diagram illustrating an emission of a low grayscale region AAL of display regions of a display panel 100 of FIG. 4 in a seventh frame period FR7B. FIG. 18 is a diagram illustrating an emission of a low grayscale region AAL of display regions of a display panel 100 of FIG. 4 in an eighth frame period FR8B. FIG. 19 is a diagram illustrating an emission of a low grayscale region AAL of display regions of a display panel 100 of FIG. 4 in a ninth frame period FR9B.

Referring to FIG. 1 to FIG. 6 and FIG. 11 to FIG. 19, a low grayscale region AAL may include a plurality of pixel groups. The pixel group of the low grayscale region AAL may be referred to as the low grayscale pixel group. The low grayscale region AAL may correspond to the even-numbered display region. The pixel group may include a plurality of pixels PX. The pixels PX of the low grayscale region AAL may emit with the first low grayscale GRL1. In an embodiment, the pixels PX of the low grayscale region AAL may emit light based on a first low grayscale data voltage corresponding to the first low grayscale GRL1, for example. When the first low grayscale GRL1 has about 0 grayscale level, the low grayscale region AAL may display black. When the first low grayscale GRL1 has about 0 grayscale level, the driving transistors included in the low grayscale region AAL may be turned off.

In an embodiment, the low grayscale pixel group may include nine pixels, for example. In an embodiment, the low grayscale pixel group may include first to ninth pixels, for example. In the illustrated embodiment, at least one pixel of the first to ninth pixels may emit with the second low grayscale GRL2. A grayscale level of the second low grayscale GRL2 may be higher than the grayscale level of the first low grayscale GRL1. The second low grayscale GRL2 may be closer to the first low grayscale GRL1 than the first high grayscale GRH1. In an embodiment, a first difference value of the second low grayscale GRL2 and the first low grayscale GRL1 may be smaller than a second difference value of the second low grayscale GRL2 and the first high grayscale GRH1, for example. In an embodiment, a first data voltage (e.g., the first high grayscale data voltage) may correspond to a maximum grayscale in which the display panel 100 emit, for example. A second data voltage (e.g., the first low grayscale data voltage) may correspond to a minimum grayscale in which the display panel 100 emit. A first voltage difference value of the third data voltage and the second data voltage may be lower than a second voltage difference value of the third data voltage and the first data voltage. In an embodiment, the second low grayscale GRL2 may be about 1 grayscale level, for example. In an embodiment, the second low grayscale GRL2 may be a grayscale level higher than about 1 grayscale level, for example. In an embodiment, the second low grayscale GRL2 may be grayscale level in which a black luminance is not affected, for example. In an embodiment, the first to ninth pixels may sequentially emit with the second low grayscale GRL2, for example. In an embodiment, the first to ninth pixels may randomly emit with the second low grayscale GRL2.

When the pixel PX emits with the first low grayscale GRL1, the driving transistor included in the pixel PX may be turned off. In an embodiment, the first low grayscale data voltage corresponding to the first low grayscale GRL1 may strongly turn off the driving transistor. In an embodiment, an absolute value of the first low grayscale data voltage may be lower than an absolute value of a threshold voltage of the driving transistor, for example. In an embodiment, a difference value of the absolute value of the first low grayscale data voltage and the absolute value of the threshold voltage of the driving transistor may be about 0.5V, for example. However, the inventive concept is not limited to the difference value. In an embodiment, the difference value may be about 1V, for example.

When the pixel PX emit with the second low grayscale GRL2, the driving transistor included in the pixel PX may be turned on. The driving transistor included in the pixel PX may be turned on, so that a hysteresis characteristic may be improved. In an embodiment, the driving transistor included in the pixel PX, an influence of the hysteresis may be reduced, for example.

In a first frame period FR1B, the first pixel may emit with the second low grayscale GRL2, the second pixel may emit with the first low grayscale GRL1, the third pixel may emit with the first low grayscale GRL1, the fourth pixel may emit with the first low grayscale GRL1, the fifth pixel may emit with the first low grayscale GRL1, the sixth pixel may emit with the first low grayscale GRL1, the seventh pixel may emit with the first low grayscale GRL1, the eighth pixel may emit with the first low grayscale GRL1, and the ninth pixel may emit with the first low grayscale GRL1. Accordingly, in the first frame period FR1B, the driving transistor of the first pixel may be turned on, the driving transistor of the second pixel may be maintained as the turned off state, the driving transistor of the third pixel may be maintained as the turned off state, the driving transistor of the fourth pixel may be maintained as the turned off state, the driving transistor of the fifth pixel may be maintained as the turned off state, the driving transistor of the sixth pixel may be maintained as the turned off state, the driving transistor of the seventh pixel may be maintained as the turned off state, the driving transistor of the eighth pixel may be maintained as the turned off state, and the driving transistor of the ninth pixel may be maintained as the turned off state. Accordingly, the hysteresis of the first pixel may be improved.

In a second frame period FR2B following to the first frame period FR1B, the first pixel may emit with the first low grayscale GRL1, the second pixel may emit with the second low grayscale GRL2, the third pixel may emit with the first low grayscale GRL1, the fourth pixel may emit with the first low grayscale GRL1, the fifth pixel may emit with the first low grayscale GRL1, the sixth pixel may emit with the first low grayscale GRL1, the seventh pixel may emit with the first low grayscale GRL1, the eighth pixel may emit with the first low grayscale GRL1, and the ninth pixel may emit with the first low grayscale GRL1. Accordingly, in the second frame period FR2B, the driving transistor of the first pixel may be turned off, the driving transistor of the second pixel may be turned on, the driving transistor of the third pixel may be maintained as the turned off state, the driving transistor of the fourth pixel may be maintained as the turned off state, the driving transistor of the fifth pixel may be maintained as the turned off state, the driving transistor of the sixth pixel may be maintained as the turned off state, the driving transistor of the seventh pixel may be maintained as the turned off state, the driving transistor of the eighth pixel may be maintained as the turned off state, and the driving transistor of the ninth pixel may be maintained as the turned off state. Accordingly, the hysteresis of the second pixel may be improved.

In a third frame period FR3B following to the second frame period FR2B, the first pixel may emit with the first low grayscale GRL1, the second pixel may emit with the first low grayscale GRL1, the third pixel may emit with the second low grayscale GRL2, the fourth pixel may emit with the first low grayscale GRL1, the fifth pixel may emit with the first low grayscale GRL1, the sixth pixel may emit with the first low grayscale GRL1, the seventh pixel may emit with the first low grayscale GRL1, the eighth pixel may emit with the first low grayscale GRL1, and the ninth pixel may emit with the first low grayscale GRL1. Accordingly, in the third frame period FR3B, the driving transistor of the first pixel may be maintained as turned off state, the driving transistor of the second pixel may be turned off, the driving transistor of the third pixel may be turned on, the driving transistor of the fourth pixel may be maintained as the turned off state, the driving transistor of the fifth pixel may be maintained as the turned off state, the driving transistor of the sixth pixel may be maintained as the turned off state, the driving transistor of the seventh pixel may be maintained as the turned off state, the driving transistor of the eighth pixel may be maintained as the turned off state, and the driving transistor of the ninth pixel may be maintained as the turned off state. Accordingly, the hysteresis of the third pixel may be improved.

In a fourth frame period FR4B following to the third frame period FR3B, the first pixel may emit with the first low grayscale GRL1, the second pixel may emit with the first low grayscale GRL1, the third pixel may emit with the first low grayscale GRL1, the fourth pixel may emit with the second low grayscale GRL2, the fifth pixel may emit with the first low grayscale GRL1, the sixth pixel may emit with the first low grayscale GRL1, the seventh pixel may emit with the first low grayscale GRL1, the eighth pixel may emit with the first low grayscale GRL1, and the ninth pixel may emit with the first low grayscale GRL1. Accordingly, in the fourth frame period FR4B, the driving transistor of the first pixel may be maintained as turned off state, the driving transistor of the second pixel may be maintained as a turned off state, the driving transistor of the third pixel may be turned off, the driving transistor of the fourth pixel may be turned on, the driving transistor of the fifth pixel may be maintained as the turned off state, the driving transistor of the sixth pixel may be maintained as the turned off state, the driving transistor of the seventh pixel may be maintained as the turned off state, the driving transistor of the eighth pixel may be maintained as the turned off state, and the driving transistor of the ninth pixel may be maintained as the turned off state. Accordingly, the hysteresis of the fourth pixel may be improved.

In a fifth frame period FR5B following to the fourth frame period FR4B, the first pixel may emit with the first low grayscale GRL1, the second pixel may emit with the first low grayscale GRL1, the third pixel may emit with the first low grayscale GRL1, the fourth pixel may emit with the first low grayscale GRL1, the fifth pixel may emit with the second low grayscale GRL2, the sixth pixel may emit with the first low grayscale GRL1, the seventh pixel may emit with the first low grayscale GRL1, the eighth pixel may emit with the first low grayscale GRL1, and the ninth pixel may emit with the first low grayscale GRL1. Accordingly, in the fifth frame period FR5B, the driving transistor of the first pixel may be maintained as the turned off state, the driving transistor of the second pixel may be maintained as the turned off state, the driving transistor of the third pixel may be turned off, the driving transistor of the fourth pixel may be turned off, the driving transistor of the fifth pixel may be turned on, the driving transistor of the sixth pixel may be maintained as the turned off state, the driving transistor of the seventh pixel may be maintained as the turned off state, the driving transistor of the eighth pixel may be maintained as the turned off state, and the driving transistor of the ninth pixel may be maintained as the turned off state. Accordingly, the hysteresis of the fifth pixel may be improved.

In a sixth frame period FR6B following to the fifth frame period FR5B, the first pixel may emit with the first low grayscale GRL1, the second pixel may emit with the first low grayscale GRL1, the third pixel may emit with the first low grayscale GRL1, the fourth pixel may emit with the first low grayscale GRL1, the fifth pixel may emit with the first low grayscale GRL1, the sixth pixel may emit with the second low grayscale GRL2, the seventh pixel may emit with the first low grayscale GRL1, the eighth pixel may emit with the first low grayscale GRL1, and the ninth pixel may emit with the first low grayscale GRL1. Accordingly, in the sixth frame period FR6B, the driving transistor of the first pixel may be maintained as the turned off state, the driving transistor of the second pixel may be maintained as the turned off state, the driving transistor of the third pixel may be maintained as the turned off state, the driving transistor of the fourth pixel may be maintained as the turned off state, the driving transistor of the fifth pixel may be turned off, the driving transistor of the sixth pixel may be turned on, the driving transistor of the seventh pixel may be maintained as the turned off state, the driving transistor of the eighth pixel may be maintained as the turned off state, and the driving transistor of the ninth pixel may be maintained as the turned off state. Accordingly, the hysteresis of the sixth pixel may be improved.

In a seventh frame period FR7B following to the sixth frame period FR6B, the first pixel may emit with the first low grayscale GRL1, the second pixel may emit with the first low grayscale GRL1, the third pixel may emit with the first low grayscale GRL1, the fourth pixel may emit with the first low grayscale GRL1, the fifth pixel may emit with the first low grayscale GRL1, the sixth pixel may emit with the first low grayscale GRL1, the seventh pixel may emit with the second low grayscale GRL2, the eighth pixel may emit with the first low grayscale GRL1, and the ninth pixel may emit with the first low grayscale GRL1. Accordingly, in the seventh frame period FR7B, the driving transistor of the first pixel may be maintained as the turned off state, the driving transistor of the second pixel may be maintained as the turned off state, the driving transistor of the third pixel may be maintained as the turned off state, the driving transistor of the fourth pixel may be maintained as the turned off state, the driving transistor of the fifth pixel may be maintained as the turned off state, the driving transistor of the sixth pixel may be turned off, the driving transistor of the seventh pixel may be turned on, the driving transistor of the eighth pixel may be maintained as the turned off state, and the driving transistor of the ninth pixel may be maintained as the turned off state. Accordingly, the hysteresis of the seventh pixel may be improved.

In an eighth frame period FR8B following to the seventh frame period FR7B, the first pixel may emit with the first low grayscale GRL1, the second pixel may emit with the first low grayscale GRL1, the third pixel may emit with the first low grayscale GRL1, the fourth pixel may emit with the first low grayscale GRL1, the fifth pixel may emit with the first low grayscale GRL1, the sixth pixel may emit with the first low grayscale GRL1, the seventh pixel may emit with the first low grayscale GRL1, the eighth pixel may emit with the second low grayscale GRL2, and the ninth pixel may emit with the first low grayscale GRL1. Accordingly, in the eighth frame period FR8B, the driving transistor of the first pixel may be maintained as the turned off state, the driving transistor of the second pixel may be maintained as the turned off state, the driving transistor of the third pixel may be maintained as the turned off state, the driving transistor of the fourth pixel may be maintained as the turned off state, the driving transistor of the fifth pixel may be maintained as the turned off state, the driving transistor of the sixth pixel may be maintained as the turned off state, the driving transistor of the seventh pixel may be turned off, the driving transistor of the eighth pixel may be turned on, and the driving transistor of the ninth pixel may be maintained as the turned off state. Accordingly, the hysteresis of the eighth pixel may be improved.

In an ninth frame period FR9B following to the eighth frame period FR8B, the first pixel may emit with the first low grayscale GRL1, the second pixel may emit with the first low grayscale GRL1, the third pixel may emit with the first low grayscale GRL1, the fourth pixel may emit with the first low grayscale GRL1, the fifth pixel may emit with the first low grayscale GRL1, the sixth pixel may emit with the first low grayscale GRL1, the seventh pixel may emit with the first low grayscale GRL1, the eighth pixel may emit with the first low grayscale GRL1, and the ninth pixel may emit with the second low grayscale GRL2. Accordingly, in the ninth frame period FR9B, the driving transistor of the first pixel may be maintained as the turned off state, the driving transistor of the second pixel may be maintained as the turned off state, the driving transistor of the third pixel may be maintained as the turned off state, the driving transistor of the fourth pixel may be maintained as the turned off state, the driving transistor of the fifth pixel may be maintained as the turned off state, the driving transistor of the sixth pixel may be maintained as the turned off state, the driving transistor of the seventh pixel may be maintained as the turned off state, the driving transistor of the eighth pixel may be turned off, and the driving transistor of the ninth pixel may be turned on. Accordingly, the hysteresis of the ninth pixel may be improved.

In the illustrated embodiment, when the display panel 100 displays the first display pattern IMP1, at least one pixel of the pixels PX included in the low grayscale region AAL may emit with the second low grayscale GRL2. In an embodiment, at least one pixel of pixels included in the low grayscale pixel group may emit with the second low grayscale GRL2. Additionally, in each of frame periods, the at least one pixel may be changed, for example. Accordingly, the driving transistor included in the at least one pixel may be turned on. Accordingly, an influence of the hysteresis may be reduced. The influence of the hysteresis may be reduced, so that a visibility of the afterimage may be reduced. Additionally, a reliability of the afterimage determination may be improved.

Additionally, in an embodiment, the second low grayscale GRL2 may be about 1 grayscale level. Accordingly, when the at least one pixel emits with the second low grayscale GRL2, the low grayscale region AAL may be displayed as black. In an embodiment, when the at least one pixel emits with the second low grayscale GRL2, the low grayscale region AAL may emit with a luminance corresponding black, for example. Accordingly, a reliability of the afterimage determination may be further improved.

Additionally, in the illustrated embodiment, the low grayscale pixel group may include a large number of the pixels PX. Accordingly, during one frame period, the number of the pixels PX which emits with the second low grayscale GRL2 may be reduced. Accordingly, the low grayscale region AAL may emit with a luminance corresponding black.

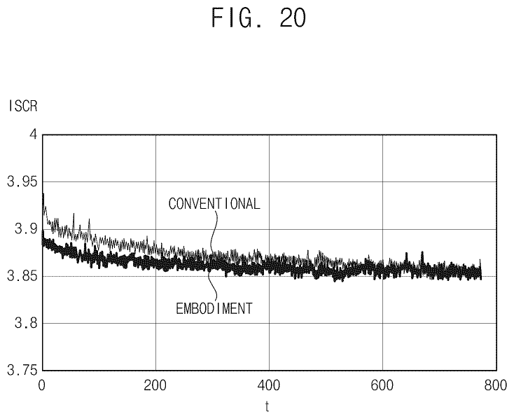

FIG. 20 is a graph illustrating an afterimage determination of a conventional display device and a display device 1 of FIG. 1.

Referring to FIG. 1 to FIG. 20, based on the first display pattern IMP1 and the second display pattern IMP2, an afterimage of the display panel 100 may be determined. In an embodiment, the display panel 100 emit with the second display pattern IMP2, by determining a luminance of the display panel 100, an afterimage may be determined, for example.

An afterimage value ISCR of the display panel 100 included in the display device 1 according to the inventive concept may be reduced compared with a conventional display device. The afterimage value ISCR may be calculated by a first equation.

$$ISCR = ( LGRH + LGRL ) / ( LGRH - L GRL ) * 10000 ) \qquad [ First equation ]$$

Herein, ISCR may denote the afterimage value, LGRH may denote a determined luminance of the high grayscale region AAH, and LGRL may denote a determined luminance of the low grayscale region AAL.

In the illustrated embodiment, when the display panel 100 displays the first display pattern IMP1, at least one pixel of the pixels PX included in the low grayscale region AAL may emit with the second low grayscale GRL2. In an embodiment, at least one pixel of pixels included in the low grayscale pixel group may emit with the second low grayscale GRL2. Additionally, in each of frame periods, the at least one pixel may be changed, for example. Accordingly, the driving transistor included in the at least one pixel may be turned on. Accordingly, an influence of the hysteresis may be reduced. The influence of the hysteresis may be reduced, so that a visibility of the afterimage may be reduced. Additionally, a reliability of the afterimage determination may be improved.

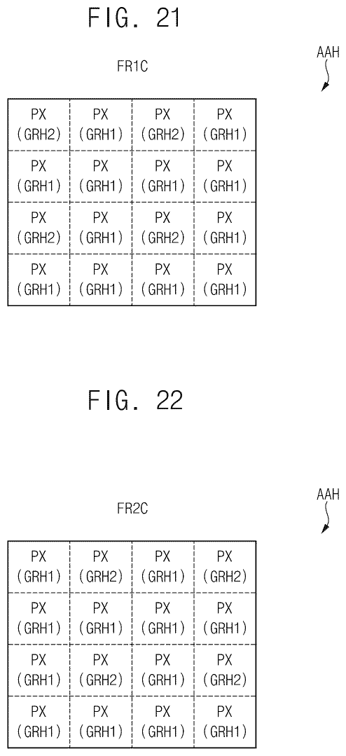

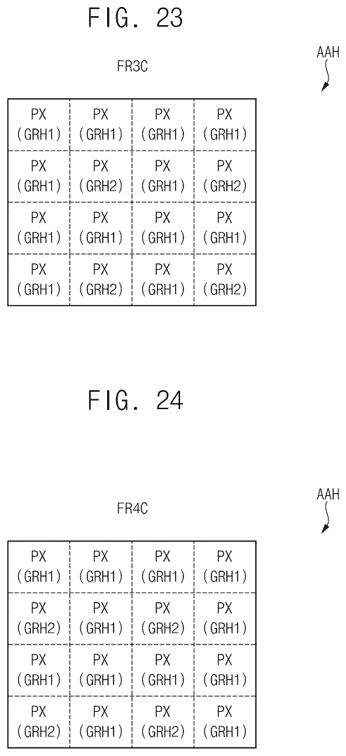

FIG. 21 is a diagram illustrating an emission of a high grayscale region AAH of display regions of a display panel 100 of FIG. 4 in a first frame period FR1C. FIG. 22 is a diagram illustrating an emission of a high grayscale region AAH of display regions of a display panel 100 of FIG. 4 in a second frame period FR2C. FIG. 23 is a diagram illustrating an emission of a high grayscale region AAH of display regions of a display panel 100 of FIG. 4 in a third frame period FR3C. FIG. 24 is a diagram illustrating an emission of a high grayscale region AAH of display regions of a display panel 100 of FIG. 4 in a fourth frame period FR4C.

Referring to FIG. 1 to FIG. 5 and FIG. 21 to FIG. 24, a high grayscale region AAH may include a plurality of pixel groups. The pixel group of the high grayscale region AAH may be referred to as a high grayscale pixel group. The high grayscale region AAH may correspond to the even-numbered display region. The pixel group may include a plurality of pixels PX. The pixels PX of the high grayscale region AAH may emit with the first high grayscale GRH1. In an embodiment, the pixels PX of the high grayscale region AAH may emit light based on a first high grayscale data voltage corresponding to the first high grayscale GRH1, for example. When the first high grayscale GRH1 has about 255 grayscale level, the high grayscale region AAH may display white.

In an embodiment, the low grayscale pixel group may include four pixels, for example. In an embodiment, the high grayscale pixel group may include first to fourth pixels, for example. In the illustrated embodiment, at least one pixel of the first to fourth pixels may emit with the second high grayscale GRH2. A grayscale level of the second high grayscale GRH2 may be lower than the grayscale level of the first high grayscale GRH1. The second high grayscale GRH2 may be closer to the first high grayscale GRH1 than the first low grayscale GRL1. In an embodiment, a first difference value of the second high grayscale GRH2 and the first high grayscale GRH1 may be smaller than a second difference value of the second high grayscale GRH2 and the first low grayscale GRL1, for example.

In an embodiment, a grayscale level of the second high grayscale GRH2 may be 1 grayscale level lower than a grayscale level of the first high grayscale GRH1, for example. In an embodiment, when the first high grayscale GRH1 is about 255 grayscale level, the second high grayscale GRH2 may be about 254 grayscale level, for example. In an embodiment, the second high grayscale GRH2 may be a grayscale level lower than about 254 grayscale level, for example. In an embodiment, the second high grayscale GRH2 may be grayscale level in which a white luminance is not affected, for example. In an embodiment, the first to fourth pixels may sequentially emit with the second high grayscale GRH2, for example. In an embodiment, the first to fourth pixels may randomly emit with the second high grayscale GRH2.

After the pixel PX emits with the first high grayscale GRH1, the pixel PX emits with the second high grayscale GRH2. Additionally, after the pixel PX emits with the second high grayscale GRH2, the pixel PX emits with the first high grayscale GRH1. Accordingly, the hysteresis characteristic of the pixel PX may be improved compared with the pixel PX emitting light only at the first high grayscale GRH1. In an embodiment, an influence of hysteresis may be reduced compared with the pixel PX emitting light only at the first high grayscale GRH1, for example.

In a first frame period FR1C, the first pixel may emit with the second high grayscale GRH2, the second pixel may emit with the first high grayscale GRH1, the third pixel may emit with the first high grayscale GRH1, and the fourth pixel may emit with the first high grayscale GRH1. Accordingly, the hysteresis of the first pixel may be improved.

In a second frame period FR2C following to the first frame period FR1C, the first pixel may emit with the first high grayscale GRH1, the second pixel may emit with the second high grayscale GRH2, the third pixel may emit with the first high grayscale GRH1, and the fourth pixel may emit with the first high grayscale GRH1. Accordingly, the hysteresis of the second pixel may be improved.

In a third frame period FR3C following to the second frame period FR2C, the first pixel may emit with the first high grayscale GRH1, the second pixel may emit with the first high grayscale GRH1, the third pixel may emit with the second high grayscale GRH2, and the fourth pixel may emit with the first high grayscale GRH1. Accordingly, the hysteresis of the third pixel may be improved.

In a fourth frame period FR4C following to the third frame period FR3C, the first pixel may emit with the first high grayscale GRH1, the second pixel may emit with the first high grayscale GRH1, the third pixel may emit with the first high grayscale GRH1, and the fourth pixel may emit with the second high grayscale GRH2. Accordingly, the hysteresis of the fourth pixel may be improved.

In the illustrated embodiment, when the display panel 100 displays the first display pattern IMP1, at least one pixel of the pixels PX included in the high grayscale region AAH may emit with the second high grayscale GRH2. In an embodiment, at least one pixel of pixels included in the high grayscale pixel group may emit with the second high grayscale GRH2, for example. Additionally, in each of frame periods, the at least one pixel may be changed. Accordingly, the driving transistor included in the at least one pixel may be turned on. Accordingly, an influence of the hysteresis may be reduced. The influence of the hysteresis may be reduced, so that a visibility of the afterimage may be reduced. Additionally, a reliability of the afterimage determination may be improved.

Additionally, in an embodiment, the second high grayscale GRH2 may be about 254 grayscale level. Accordingly, when the at least one pixel emits with the second high grayscale GRH2, the high grayscale region AAH may be displayed as white. In an embodiment, when the at least one pixel emits with the second high grayscale GRH2, the high grayscale region AAH may emit with a luminance corresponding white, for example. Accordingly, a reliability of the afterimage determination may be further improved.

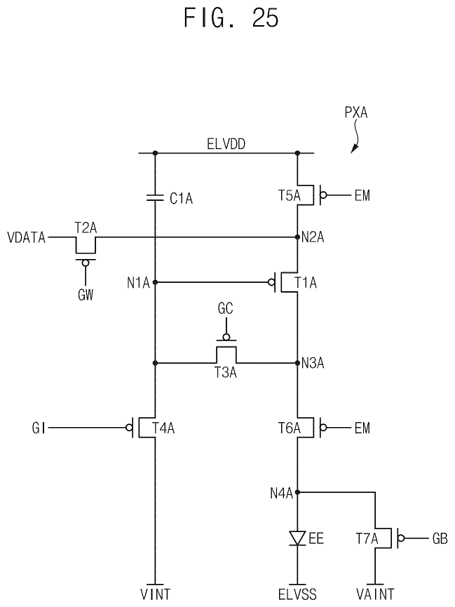

FIG. 25 is a circuit diagram illustrating an embodiment of a pixel PX included a display device 1 of FIG. 1.

Referring to FIG. 1 and FIG. 25, a pixel PXA may include a first transistor T1A, a second transistor T2A, a third transistor T3A, a fourth transistor T4A, a fifth transistor T5A, a sixth transistor T6A, a seventh transistor T7A, a storage capacitor C1A and the light emitting element EE.

The first transistor T1A may include a control electrode connected to a first node N1A, a first electrode connected to a second node N2A and a second electrode connected to a third node N3A. The first transistor T1A may generate a driving current based on a voltage of the first node N1A. In an embodiment, the first transistor T1A may be referred to as the driving transistor, for example. In the illustrated embodiment, the first transistor T1A may be P-type transistor.

The second transistor T2A may include a control electrode receiving a write gate signal GW, a first electrode receiving the data voltage VDATA and a second electrode connected to the second node N2A. The second transistor T2A may apply the data voltage VDATA to the second node N2A in response to the write gate signal GW. In an embodiment, the second transistor T2A may be referred to as the write transistor, for example.

The third transistor T3A may include a control electrode receiving the compensation gate signal GC, a first electrode connected to the third node N3A and a second electrode connected to the first node N1A. The third transistor T3A may connect the first node N1A and the third node N3A in response to the compensation gate signal GC. In an embodiment, the third transistor T3A may diode-connect the first transistor T1A in response to the compensation gate signal GC, for example. In an embodiment, the third transistor T3A may be referred to as the compensation transistor, for example.

The fourth transistor T4A may include a control electrode receiving the initialization gate signal GI, a first electrode receiving the initialization voltage VINT and a second electrode connected to the first node N1A. The fourth transistor T4A may apply the initialization voltage VINT to the first node N1A in response to the initialization gate signal GI. In an embodiment, the fourth transistor T4A may be referred to as the initialization transistor, for example.

The fifth transistor T5A may include a control electrode receiving the emission signal EM, a first electrode receiving the first power voltage (also referred as a high power voltage) ELVDD and a second electrode connected to the second node N2A. The fifth transistor T5A may apply the high power voltage ELVDD to the second node N2A in response to the emission signal EM. In an embodiment, the fifth transistor T5A may be referred to as a first emission transistor, for example.

The sixth transistor T6A may include a control electrode receiving the emission signal EM, a first electrode connected to the third node N3A and a second electrode connected to a fourth node N4A. The sixth transistor T6A may connect the third node N3A and the fourth node N4A in response to the emission signal EM. In an embodiment, the sixth transistor T6A may be referred to as a second emission transistor, for example.

The seventh transistor T7A may include a control electrode receiving the bias gate signal GB, a first electrode receiving the light emitting element initialization voltage VAINT and a second electrode connected to the fourth node N4A. The seventh transistor T7A may apply the initialization voltage VAINT to the fourth node N4A in response to the initialization gate signal GB.

The storage capacitor C1A may include a first electrode receiving the high power voltage ELVDD and a second electrode connected to the first node N1A. The storage capacitor C1A may store a voltage of the first node N1A. In an embodiment, the first capacitor C1A may be referred to as a storage capacitor, for example.

The light emitting element EE may include a first electrode connected to the fourth node N4A and a second electrode receiving the second power voltage (also referred to as a low power voltage) ELVSS. The light emitting element EE may emit light based on the driving current.

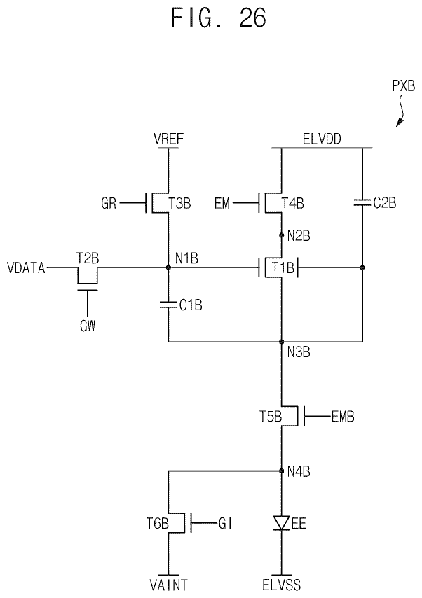

FIG. 26 is a circuit diagram illustrating an embodiment of a pixel PX included a display device 1 of FIG. 1.

Referring to FIG. 1 and FIG. 26, a pixel PXB may include a first transistor T1B, a second transistor T2B, a third transistor T3B, a fourth transistor T4B, a fifth transistor T5B, a sixth transistor T6B, a first capacitor C1B and the light emitting element EE. In an embodiment, the pixel PXB may further include a second capacitor C2B.

The first transistor T1B may include a control electrode connected to a first node N1B, a first electrode connected to a second node N2B and a second electrode connected to a third node N3B. The first transistor T1B may generate the driving current based on a voltage of the first node N1B. In an embodiment, the first transistor T1B may further include a second control electrode connected to the third node N3B. In an embodiment, the first transistor T1B may be referred to as the driving transistor, for example. In the illustrated embodiment, the first transistor T1B may be an N-type transistor.

The second transistor T2B may include a control electrode receiving the write gate signal GW, a first electrode receiving the data voltage VDATA and a second electrode connected to the first node N1B. The second transistor T2B may apply the data voltage VDATA to the first node N1B in response to the write gate signal GW. In an embodiment, the second transistor T2B may be referred to as the write transistor, for example.

The third transistor T3B may include a control electrode receiving a reset gate signal GR, a first electrode receiving a pixel reference voltage VREF and a second electrode connected to the first node N1B. The third transistor T3B may apply the pixel reference voltage VREF to the first node N1B in response to the reset gate signal GR. In an embodiment, the third transistor T3B may be referred to as the initialization transistor, for example.

The fourth transistor T4B may include a control electrode receiving an emission signal EM, a first electrode receiving the first power voltage ELVDD and a second electrode connected to the second node N2B. The fourth transistor T4B may apply the first power voltage ELVDD to the second node N2B in response to the emission signal EM. In an embodiment, the fourth transistor T4B may be referred to as the first emission transistor, for example.

The fifth transistor T5B may include a control electrode receiving a second emission signal EMB, a first electrode connected to the third node N3B and a second electrode connected to a fourth node N4B. The fifth transistor T5B may connect the third node N3B and the fourth node N4B in response to the second emission signal EMB. In an embodiment, the fifth transistor T5B may be referred to as the second emission transistor, for example.

The sixth transistor T6B may include a control electrode receiving the initialization gate signal GI, a first electrode receiving the light emitting element initialization voltage VAINT and a second electrode connected to the fourth node N4B. The sixth transistor T6B may apply the light emitting element initialization voltage VAINT to the fourth node N4B in response to the initialization gate signal GI. In an embodiment, the sixth transistor T6B may be referred to as the light emitting element initialization transistor, for example.

The first capacitor C1B may include a first electrode connected to the first node N1B and a second electrode connected to the third node N3B. The second capacitor C2B may include a first electrode receiving the first power voltage ELVDD and a second electrode connected to the third node N3B.

The light emitting element EE may include a first electrode connected to the fourth node N4B and a second electrode receiving the second power voltage ELVSS. The light emitting element EE may emit light based on the driving current.

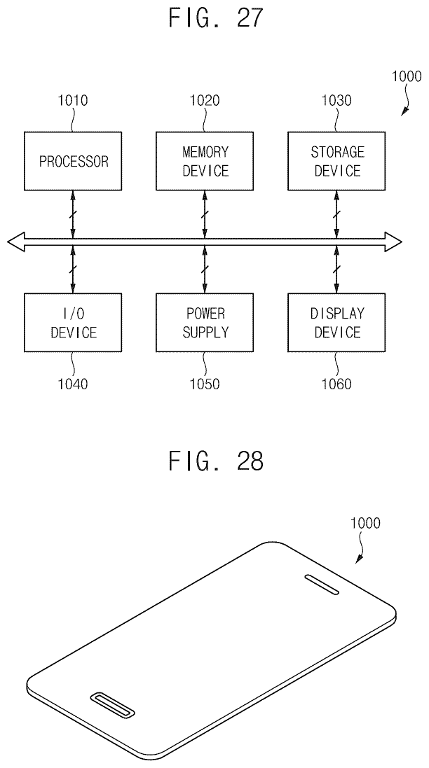

FIG. 27 is a block diagram illustrating an embodiment of an electronic device 1000 according to the inventive concept. FIG. 28 is a diagram illustrating an embodiment in which the electronic device of FIG. 27 is implemented as a smart phone.

Referring to FIG. 27, the electronic device 1000 may include a processor 1010, a memory device 1020, a storage device 1030, an input/output (“I/O”) device 1040, a power supply 1050, and a display apparatus 1060. Here, the display apparatus 1060 may be the display apparatus of FIG. 1. Additionally, the electronic device 1000 may further include a plurality of ports for communicating with a video card, a sound card, a memory card, a universal serial bus (“USB”) device, other electronic device, etc.

In an embodiment, as illustrated in FIG. 28, the electronic device 1000 may be implemented as a smart phone. However, the electronic device 1000 is not limited thereto. In an embodiment, the electronic device 1000 may be implemented as a cellular phone, a video phone, a smart pad, a smart watch, a tablet personal computer, a car navigation system, a computer monitor, a laptop, a head mounted display (“HMD”) device, or the like, for example.

The processor 1010 may perform various computing functions or various tasks. The processor 1010 may be a micro-processor, a central processing unit (“CPU”), an application processor (“AP”), or the like. The processor 1010 may be coupled to other components via an address bus, a control bus, a data bus, etc. Further, the processor 1010 may be coupled to an extended bus such as a peripheral component interconnection (“PCI”) bus.

The processor 1010 may output the input image data IMG, the app-on signal and the input control signal CONT to the driving controller 200 of FIG. 1.

The memory device 1020 may store data for operations of the electronic device 1000. In an embodiment, the memory device 1020 may include at least one non-volatile memory device such as an erasable programmable read-only memory (“EPROM”) device, an electrically erasable programmable read-only memory (“EEPROM”) device, a flash memory device, a phase change random access memory (“PRAM”) device, a resistance random access memory (“RRAM”) device, a nano floating gate memory (“NFGM”) device, a polymer random access memory (“PoRAM”) device, a magnetic random access memory (“MRAM”) device, a ferroelectric random access memory (“FRAM”) device, or the like and/or at least one volatile memory device such as a dynamic random access memory (“DRAM”) device, a static random access memory (“SRAM”) device, a mobile DRAM device, or the like, for example.

The storage device 1030 may include a solid state drive (“SSD”) device, a hard disk drive (“HDD”) device, a compact disc read-only memory (“CD-ROM”) device, or the like. The I/O device 1040 may include an input device such as a keyboard, a keypad, a mouse device, a touch-pad, a touch-screen, or the like and an output device such as a printer, a speaker, or the like. In some embodiments, the display apparatus 1060 may be included in the I/O device 1040. The power supply 1050 may provide power for operations of the electronic device 1000. The display apparatus 1060 may be coupled to other components via the buses or other communication links.

Referring to FIG. 28, the electronic device of the inventive concept is shown implemented as a smartphone, but the inventive concept is not limited thereto. The electronic device may be a television, a monitor, a laptop computer, or a tablet. Additionally, the electronic device may be a car.

The display device in the embodiments may be applied to a display device included in a computer, a notebook, a mobile phone, a smart phone, a smart pad, a portable media player (“PMP”), a personal digital assistance (“PDA”), a motion pictures expert group audio layer III (“MP3”) player, or the like.

The foregoing is illustrative of the inventive concept and is not to be construed as limiting thereof. Although a few embodiments of the inventive concept have been described, those skilled in the art will readily appreciate that many modifications are possible in the embodiments without materially departing from the novel teachings and advantages of the inventive concept. Accordingly, all such modifications are intended to be included within the scope of the inventive concept as defined in the claims. In the claims, means-plus-function clauses are intended to cover the structures described herein as performing the recited function and not only structural equivalents but also equivalent structures. Therefore, it is to be understood that the foregoing is illustrative of the inventive concept and is not to be construed as limited to the illustrative embodiments disclosed, and that modifications to the disclosed embodiments, as well as other embodiments, are intended to be included within the scope of the appended claims. The inventive concept is defined by the following claims, with equivalents of the claims to be included therein.

What is claimed is:

1. A display device comprising:
a display panel configured to emit with a first display pattern during a first time period, the display panel including:
a plurality of display regions; and
a display panel driver configured to drive the display panel,
wherein in response to a state in which the display panel emits with the first display pattern, a first display region emits with a first high grayscale, and a second display region emits with a first low grayscale lower than the first high grayscale, and
wherein in response to the state in which the display panel emits with the first display pattern, at least one pixel of the second display region emits with a second low grayscale which is inconsistent with the first high grayscale and the first low grayscale.

2. The display device of claim 1, wherein the first display pattern is a mosaic pattern which is a first sub-pattern emitting as the first high grayscale and a second sub-pattern emitting as the first low grayscale are alternatively disposed.

3. The display device of claim 1, wherein the first high grayscale is a maximum grayscale in which the display panel emits, the first low grayscale is a minimum grayscale in which the display panel emits, and a first difference value of the second low grayscale and the first low grayscale is smaller than a second difference value of the second low grayscale and the first high grayscale.

4. The display device of claim 3, wherein the first low grayscale is 0 grayscale level, and the second low grayscale is a grayscale level which is same or higher than 1 grayscale level.

5. The display device of claim 3, wherein the at least one pixel includes:
a driving transistor configured to generate a driving current based on a data voltage; and
a light emitting element configured to emit light based on the driving current,
wherein in response to a state in which a second data voltage corresponding to the first low grayscale is applied to the driving transistor, the driving transistor is turned off, and
wherein in response to a state in which a third data voltage corresponding to the second low grayscale is applied to the driving transistor, the driving transistor is turned on.

6. The display device of claim 1, wherein the second display region includes a first pixel to a fourth pixel, and
wherein in response to the state in which the display panel emits with the first display pattern, the first pixel to the fourth pixel sequentially emit with the second low grayscale.

7. The display device of claim 6, wherein frame periods in which the display panel is driven includes a first frame period to a fourth frame period,
wherein in the first frame period, the first pixel emits with the second low grayscale, the second pixel emits with the first low grayscale, the third pixel emits with the first low grayscale, and the fourth pixel emits with the first low grayscale,
wherein in the second frame period following to the first frame period, the first pixel emits with the first low grayscale, the second pixel emits with the second low grayscale, the third pixel emits with the first low grayscale, and the fourth pixel emits with the first low grayscale,
wherein in the third frame period following to the second frame period, the first pixel emits with the first low grayscale, the second pixel emits with the first low grayscale, the third pixel emits with the second low grayscale, and the fourth pixel emits with the first low grayscale, and
wherein in the fourth frame period following to the third frame period, the first pixel emits with the first low grayscale, the second pixel emits with the first low grayscale, the third pixel emits with the first low grayscale, and the fourth pixel emits with the second low grayscale.

8. The display device of claim 1, wherein the second display region includes a first pixel to a ninth pixel, and
wherein in response to the state in which the display panel emit with the first display pattern, the first pixel to the ninth pixel sequentially emit with the second low grayscale.

9. The display device of claim 1, wherein the second display region includes a plurality of pixel groups,
wherein each of the plurality of pixel groups includes a plurality of pixels, and
wherein in response to the state in which the display panel emits with the first display pattern, at least one pixel of the plurality of pixels emit with the second low grayscale.

10. The display device of claim 1, wherein during a second time period following to the first time period, the display panel emits with a reference display pattern, and
wherein the reference display pattern is an image in which an entirety of the display panel emits with a reference grayscale.

11. The display device of claim 1, wherein the display panel emits with the first display pattern, at least one pixel of the plurality of pixels included in the first display region emit with a second high grayscale which is inconsistent with the first high grayscale, the first low grayscale and the second low grayscale.

12. The display device of claim 11, wherein the first high grayscale is a maximum grayscale in which the display panel emits, the first low grayscale is a minimum grayscale in which the display panel emits, a first difference value of the second low grayscale and the first low grayscale is smaller than a second difference value of the second low grayscale and the first high grayscale, and
wherein a third difference value of the second high grayscale and the first high grayscale is smaller than a fourth difference value of the second high grayscale and the first low grayscale.

13. The display device of claim 12, wherein the first high grayscale is 255 grayscale level, the first low grayscale is 0 grayscale level, the second low grayscale is a grayscale level which is same or higher than 1 grayscale level, and the second high grayscale is a grayscale level which is same or lower than 254 grayscale level.

14. An electronic device comprising:
a processor configured to output input image data and an input control signal;
a display panel configured to emit with a first display pattern during a first time period, the display panel including:
a plurality of display regions; and
a display panel driver configured to drive the display panel based on the input image data and the input control signal,
wherein in response to the state in which the display panel emits with the first display pattern, a first display region emits with a first high grayscale, and a second display region emits with a first low grayscale lower than the first high grayscale, and
wherein in response to the state in which the display panel emits with the first display pattern, at least one pixel of the second display region emits with a second low grayscale which is inconsistent with the first high grayscale and the first low grayscale.

15. The electronic device of claim 14, wherein the first display pattern is a mosaic pattern which is a first sub-pattern emitting as the first high grayscale and a second sub-pattern emitting as the first low grayscale are alternatively disposed.

16. The electronic device of claim 14, wherein the first high grayscale is a maximum grayscale in which the display panel emits, the first low grayscale is a minimum grayscale in which the display panel emits, and a first difference value of the second low grayscale and the first low grayscale is smaller than a second difference value of the second low grayscale and the first high grayscale.

17. The electronic device of claim 16, wherein the at least one pixel includes:
a driving transistor configured to generate a driving current based on a data voltage; and
a light emitting element configured to emit light based on the driving current,
wherein in response to a state in which a second data voltage corresponding to the first low grayscale is applied to the driving transistor, the driving transistor is turned off, and
wherein in response to a state in which a third data voltage corresponding to the second low grayscale is applied to the driving transistor, the driving transistor is turned on.

18. A display device comprising:
a display panel configured to emit with a first display pattern during a first time period, the display panel including:
a plurality of display regions; and
a display panel driver configured to drive the display panel,
wherein in response to a state in which the display panel emits with the first display pattern, a first data voltage is applied to a first display region, and a second data voltage which is inconsistent with the first data voltage is applied to a second display region, and
wherein in response to the state in which the display panel emits with the first display pattern, a third data voltage which is inconsistent with the first data voltage and the second data voltage is applied to at least one pixel included in the second display region.

19. The display device of claim 18, wherein the first display pattern is a mosaic pattern which is a first sub-pattern displaying white and a second sub-pattern displaying black are alternatively disposed.

20. The display device of claim 18, wherein the first data voltage corresponds to a maximum grayscale in which the display panel emits, the second data voltage corresponds to a minimum grayscale in which the display panel emits, and a first difference value of the third data voltage and the second data voltage is smaller than a second difference value of the third data voltage and the first data voltage.
